(19) United States
(12) Patent Application Publication
(10) Pub. No.: US 2007/0131765 A1
(43) Pub. Date: Jun. 14, 2007

(54) System and method for automatic processing of special service logistic

(76) Inventors: Moon-Sung Park, Daejon (KR); In-Soo Kim, Daejon (KR); Wan-Seok Kim, Daejon (KR); Jong-Heung Park, Daejon (KR)

Correspondence Address: LADAS & PARRY LLP, 224 SOUTH MICHIGAN AVENUE, SUITE 1600, CHICAGO, IL, 60604, US

(21) Appl. No.: 11/593,623

(22) Filed: Nov. 6, 2006

(30) Foreign Application Priority Data
Dec. 9, 2005 (KR) 10-2005-0121052
Jun. 19, 2006 (KR) 10-2006-0055077

(51) Int. Cl. G06Q 30/00

(52) U.S. Cl. 235/385

(57) ABSTRACT

A system and method for automatic processing of special service logistic including a registered mail, a credit card, an insured mail, a receiver confirm mail and billing to mail receiver are provided. The system and method for automatic processing of special service logistic improves the rate of auto processing articles and provides the reliability and the security of the processing result through automatically processing the article and creating the delivery information thereof using receipt information although a postcode is not present in a barcode.

### FIELD OF THE INVENTION

The present invention relates to a system and method for automatic processing of special service logistic for automatically sorting articles and creating delivery information thereof not only when the article includes a barcode with sort information but also when the article includes a barcode without sort information in receiving the articles and packaging the articles; and, more particularly, to a system and method for automatic processing of special service logistic for sorting reception information created by a barcode without a postcode and transferring the sorted reception information to a corresponding distribution center (or mail sorting center), providing a method for automatically searching reception information and removing unnecessary information from the reception information in order to automatically process articles in high speed by sorting necessary information only, and for managing a distribution center and providing a article processing result notification service to customers by automatically and accurately generating delivery information, automatically processing returned articles and transferring a result of processing returning information at the same time.

### DESCRIPTION OF RELATED ARTS

Conventionally, articles were automatically processed using related technologies such as a method for using a barcode to automatically process mails when an address or a postcode is not recognized at an automatic sorting process, which was introduced in U.S. Pat. No. 6,894,234B1, a method for effectively supporting the creation and preparation of receiving a large quantity of mails and accurately calculating a postage based on an auto-sorting result of received mails, which was introduced in U.S. Pat. No. 6,101,487, and a method for attaching a barcode label in order to automatically re-delivering returned mails or forwarding mails to new address, which is a method for processing an undeliverable mail as address in Japan.

As described above, these conventional technologies were introduced to effectively and automatically process mails through a method for automatically sorting and processing un-recognized mails in order to expand the object of automatic mail processing and a method for applying auto-sorting data to mails when mails are received, printing a barcode for the re-delivering mails due to returning and address forwarding, and using the barcode. However, these conventional technologies fail to teach a method for automatically processing mails according to a barcode without sorting information. Currently, letters without sorting information and letters with a barcode with service numbers only cannot be automatically processed according to theses conventional technologies. Therefore, these letters are manually processed.

Meanwhile, an auto-sorting function generally embeds a postcode into a barcode in order to maximize the efficiency of auto-sorting mails. However, the postcodes may be not frequently included in the barcode during a reception procedure. In order to automatically process mails by recognizing a postcode, recognized mails are automatically processed and not-recognized mails are process using the conventional method introduced in U.S. Pat. No. 6,894,234 B1. Such a method was introduced to effectively and automatically processing mails.

In case of delivering or distributing articles, a distribution center must have capability to automatically sort the articles using a postcode to provide recipient confirmation information although sorting information is not included in a barcode or input information, and must automatically create delivery information for providing a delivery tracking service and for effective transfer of delivery.

That is, high-quality services are not required for delivering general mails. Generally, typical mails are delivered with a sufficient delivering time. Therefore, if a mail is faulty sorted and delivered, the mail can be resorted at a next distribution center to deliver the mail to a correct address. However, articles for a special delivering service must be delivered one or two days using a reliable sorting method and provide information related to the delivering of the articles. Therefore, there is a demand for a technology for automatically processing the articles using information inputted when the articles are registered to be delivered.

### SUMMARY OF THE INVENTION

It is, therefore, an object of the present invention to provide a system and method for automatic processing of special service logistic for automatically sorting articles and creating delivery information (is information into packaging unit for transportation between from reception office (or postal office counter) to distribution center or distribution centers) using necessary information among receipt information when a postcode or auto-sorting information is not included in a barcode that is obtained from image information of article in auto-processing step in order to effectively recognize the article information.

In accordance with an aspect of the present invention, there is provided a system for automatic processing of special service logistic, the system including: an article receiving unit for sorting target articles by a type using receipt information and transferring the sorted articles to a distribution center; an article integrated information unit for receiving receipt information from the article receiving unit, classifying the received receipt information by the distribution center that performs outward sorting, inward sorting, and transferring the classified receipt information to the distribution center; a receipt information matching unit for classifying the receipt information into outward sorting and inward sorting by transferring the receipt information from the article integrated information unit to the article receiving unit, arranging the receipt information in an assigned order to provide a special service by a reception office and a customer ID, selectively using an inward classification storing unit regardless of outward and inward classification information, transferring the receipt information to an auto-sort and delivery information creating unit, and removing and managing receipt information used by the result of ended operation and having an expired valid date; an auto-sort and delivery information generating unit for storing receipt information received by the receipt information matching unit into a predetermined database, reading a barcode of mail supplied for auto-processing, delivering the supplied mail to a corresponding sorting section if a postcode is present in the mail, automatically processing articles by searching a postcode from the database if the postcode is not present, and automatically creating delivery information with article information included in a packaging operation of the articles in a sorting section; an distribution center interfacing unit for marking receipt information used at the auto-soft and delivery information creating unit and transferring the marked receipt information to the receipt information matching unit, and transferring the delivery information to the article integrated information unit; and a return and reply information processing unit for receiving and processing a special service return and reply article.

In accordance with another aspect of the present invention, there is also provided a method for automatic processing of special service logistic, the method including the steps of: a) transferring receipt information and delivery information by receiving an article for a special service; b) distributing the receipt information created at the step a) from an article integrated information system to each distribution center; c) matching the receipt information from the article integrated information system to the distribution center receipt information matching system and transferring the receipt information; d) removing receipt information after automatically classifying and creating delivery information at the receipt information matching system and providing residual state information of the receipt information; e) removing unnecessary receipt information using a result of manual process by the distribution center receipt information matching system; f) storing receipt information received by the auto sorting process; g) automatically sorting and processing articles for a special service; and h) creating delivery information using a result of auto sorting the articles for special service.

### BRIEF DESCRIPTION OF THE DRAWINGS

The above and other objects and features of the present invention will become better understood with regard to the following description of the preferred embodiments given in conjunction with the accompanying drawings, in which:

FIG. 1 is a block diagram illustrating a system for automatic processing of special service logistic in accordance with an embodiment of the present invention;

FIG. 2 is a block diagram illustrating the reception system shown in FIG. 1;

FIG. 3 is a block diagram illustrating the reception information matching system shown in FIG. 1;

FIG. 4 is a block diagram illustrating an auto sorting and delivery information generating system of FIG. 1;

FIG. 5 is a block diagram illustrating the return and reply information processing and transferring system shown in FIG. 1 for describing a step for receiving and processing a returned and replying article; and

FIGS. 6A to 6H are flowcharts showing a method for automatic processing of special service logistic in accordance with an embodiment of the present invention.

### DETAILED DESCRIPTION OF THE INVENTION

Hereinafter, to a system and method for automatic processing of special service logistic in accordance with a preferred embodiment of the present invention will be described in more detail with reference to the accompanying drawings.

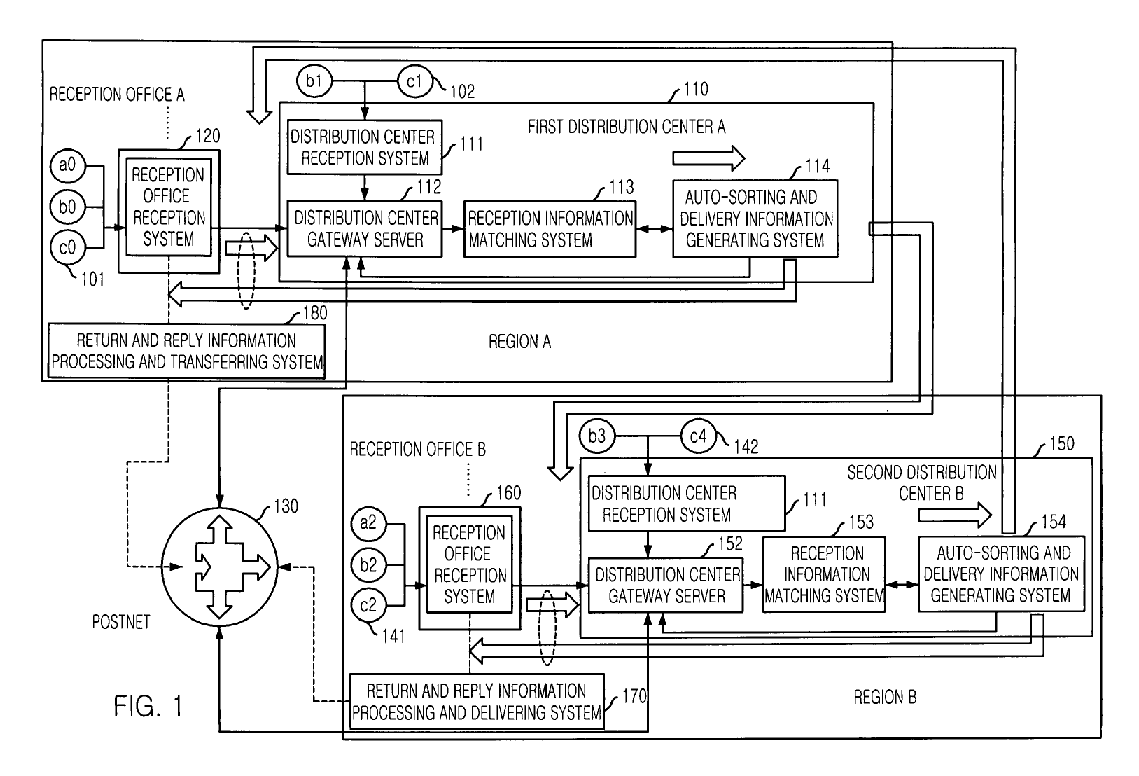

FIG. 1 is a block diagram illustrating a system for automatic processing of special service logistic in accordance with an embodiment of the present invention.

Referring to FIG. 1, The system according to the present embodiment includes first and second distribution centers (or outward and inward sorting centers) 110 and 150, first and second distribution center reception systems 111 and 151, first and second reception office reception systems 120 and 160, an incorporated distribution information system 130, first and second reception information matching systems 113 and 153, first and second auto-sorting and delivery information generating system 114 and 154, first and second distribution center gateway server 112 and 152, and first and second return and reply information processing and delivering system 180 and 170. The incorporated distribution information system 130 is also labeled with “POSTNET” in FIG. 1, and this labeled term “POSTNET” will be used hereinafter to refer this information system 130. The reception systems 111, 120, 151 and 160 sort and transfer target articles that require receipt information to the corresponding distribution centers 110 or 150. The POSTNET 130 receives the receipt information from the reception systems 111, 120, 151 and 160. Afterwards, the POSTNET 130 sorts the received receipt information for each distribution center, i.e., the first and second distribution centers 110 and 150, where outward and inward sorting operations are to be executed and, transfers the classified receipt information to the first and second distribution centers 110 and 150. As the POSTNET 130 finishes transferring the classified receipt information to the first and second distribution centers 110 and 150, the outward and inward reception information matching systems 113 and 153 sort the receipt information into a outward part and an inward part and, align the sorted receipt information in an assigned order or store the sorted receipt information in a temporal receipt order to provide a special service per a reception office and a customer identification number. The first and second reception information matching systems 113 and 153 transfer the receipt information to the first and second auto-sorting and delivery information generating system 114 and 154. Also, the first and second reception information matching systems 113 and 153 delete those pieces of the receipt information that has been already used or expired based on the finished operation result and manage the receipt information. The first and second auto-sorting and delivery information generating system 114 and 154 store the remaining pieces of the receipt information that has been received from the first and second reception information matching systems 113 and 153 on more than five databases including a outward database, an inward database, a reception station database, a customer identification database, and a return and reply classifying information database or on one database. The first and second auto-sorting and delivery information generating system 114 and 154 read barcodes of supplied pieces of mail for automatic processing. Afterwards, the first and second auto-sorting and delivery information generating system 114 and 154 make the supplied pieces of mail be transferred to corresponding sorting sections if the target articles have postcodes, and if not, search for postcodes from a receipt information database and classify the target articles automatically. Also, the first and second auto-sorting and delivery information generating system 114 and 154 generate pieces of delivery information for the target articles placed in the sorting section using pieces of detailed articles information included within a conjoining operation for a box (or tray). The first and second distribution center gateway servers 112 and 152 mark those pieces of the receipt information used in the first and second auto-sorting and delivery information generating system 114 and 154 and then, transfer the marked pieces of the receipt information to the first and second reception information matching systems 113 and 153 and the delivery information to the POSTNET 130. The first and second return and reply information processing and delivering system 180 and 170 receive and work on special service return and reply articles.

Although the types of articles are diversity, the target objects 101, 102, 141 and 142 for automatically processing may be sorted into several cases as follows.

The first case is a case of printing a barcode with a postcode after inputting a recipient's postcode when a small quantity of articles is registered individually. The second case is a case of independently inputting or recognizing reception information after issuing a barcode without a postcode without inputting all information. The third case is a case of individually providing a postcode file without printing a barcode with a postcode based on a rule made by major customer who generally request large quantity of articles to delivery. The fourth case is a case of receiving an article by printing a barcode with a postcode by the major customer.

Therefore, the reception systems 111, 120, 151 and 160 separately sort the information of target article for auto-processing using the reception information when the articles are received and sorted into the described cases. Also, the reception systems 111, 120, 151 and 160 transfer reception information which can be sorted by a mail class, a service class, a destination and a sorting plan.

The POSTNET 130 distributes reception information for auto-processing to a corresponding distribution center through the reception systems 111, 120, 151 and 160.

The reception information matching systems 113 and 153 receiving auto-processing information from the distribution center gateway servers 112 and 152 through the POSTNET 130. Then, the reception information matching systems 113 and 153 classifies information about small articles that can be processed by a machine for auto-processing and uploads necessary information to a sorting informant managing unit of the corresponding auto-processing system. Herein, the information about small articles that can be processed by a machine can be classified into the type of article such as a small typical article, a parcel and a large article.

The auto-sorting and delivery information generating systems 114 and 154 stores and manages reception information which is data for sorting. The auto-sorting and delivery information creating systems 114 and 154 sort the reception information into inward information and delivery information if a receiver's postcode is not present after reading the barcode thereof. The auto-sorting and delivery information creating systems 114 and 154 sort and process the articles according to registered postcodes by searching information in an order of the IDs of reception offices or major customers and the unique numbers of articles. At the same time, the auto-sorting and delivery information creating systems 114 and 154 store the unique numbers of articles stacked in each sorting section and creates the delivery information in a storing and processing step. Then, the auto-storing and outward the created delivery information is transmitted to the POSTNET 130.

Meanwhile, a system for automatic processing of special service logistic according to the present embodiment includes a function for managing outward and inward information and sorting plan information in order to sort the articles, and a function for automatically processing the articles by accessing reception information for a corresponding sorting plan by the selected sorting plan. Also, a system for automatic processing of special service logistic according to the present embodiment includes a function for automatically sorting and processing articles by a postcode registered to the ID of a major customer or a person who receiving article and a postal office for the ID of the reception office after recognizing returning and replaying articles by a service number or an ID, for example, a block box printed on a predetermined location of the returning and replaying articles.

Also, obtained information such as a processing time, a reception office number, a customer ID number, a distribution center ID is transmitted to the POSTNET 130 in order to inform the customer. Furthermore, a mail ID and a mail box ID are only transmitted to the POSTNET 130 if it is necessary.

Additionally, delivery information is created after concluding the outward sorting, and the created delivery information is transmitted to a distribution center for inward sorting. Since the postcodes of articles are included in the delivery information, an inward sorting distribution center uses a postcode and an article ID number, which are included in the delivery information, in order to automatically sort and process articles without using received reception information.

If a customer brings a number of articles to deliver at about a closing time of receiving articles or a time of transferring articles to a distribution center, the articles are processed by including necessary information in a barcode without a postcode in order to optimize a closing process for receiving articles and sustain the quality of delivering service. Also, a unique ID number is previously assigned to a major customer who generally requires a number of articles to deliver, and assigned barcodes without a postcode are previously printed to receive the articles from the major customer.

The object of the present invention is to minimize the load of processing articles by automatically sorting articles without sorting information influenced at a step of receiving articles for a special delivery service and automatically creating delivery information.

In the present invention, the articles can be received as individuals, the small number of articles less than 100 letters or a number of articles. Generally, when the articles are received, a barcode including sorting information is printed by inputting reception information and the barcode is attached at the articles. In order to minimize the waiting time of a customer, a barcode is created by assigning service ID numbers as a sequence number without including the sorting information and the barcode is attached at the article. After concluding the receiving process, detail of reception information inputs and is transmitted to a next distribution center.

Furthermore, a sequence number may be assigned to a customer as many as the quantity of articles through an e-mail when the customer requests the special services for the small or large quantity of the articles. In this case, a barcode without classification information may be used. A customer may receive reception file including classification information after registering the articles. Since such articles do not include classification for auto-processing, the articles are manually processed or are processed through text recognition. Since the article for special service must be processed and delivered in one or two days, it must prevent the articles from being faulty classified. Therefore, the faulty deliver caused by a faulty recognition must be minimized. Therefore, the system according to the present invention applies an auto processing method using reliable receipt information to improve the rate of auto-processing.

Also, the present invention relates to a system for effectively and automatically processing the information of articles, and more particularly, to a system for automatically classifying and creating delivery information although classification information such as a postcode is not included in a barcode in a process of obtaining image information of articles and automatically processing the obtained image information. Furthermore, the system according to the present invention effectively transfers and manages receipt information. The system according to the present invention may include more than five databases for storing information about outward, inward, receipt office, customer ID, return and reply classification information in order to quickly search a postcode although a large quantity of receipt information is processed. Such information may be stored in one database. The auto-processing system according to the present invention may include a function for removing concluded classification information for high-speed searching and using, and for removing reception information that passes a valid data. And, the present invention provides a system for classifying receipt information by outward and inward information and transferring the classified information to a distribution center. The present invention also provides a receipt information matching system for removing unnecessary information from the received receipt information, or for classifying the received receipt information by the types of articles and transferring the classified information to corresponding auto-processing systems. And, the present invention provides an operation for transferring results of creating the delivery information to the POSTNET, and marking the used receipt information and transferring the marked receipt information to the receipt information matching system. Also, the present invention provides an operation for creating a table of service sequence numbers of articles by classification sections, and reading a barcode attached at the bottom of the classification sections. Furthermore, the present invention provides a method for reading a destination barcode attached at the box of the article, reading a barcode of an article lastly left at a corresponding classification section, and creating information about a mother-and-child relation of the read barcode information with articles in the article box. Such a method may be used to perform when the article box is filled up.

In addition, the auto-processing system according to the present invention may include an operation for creating delivery information by sorting data in an order of a reception office ID or a customer ID, a distribution center ID or a delivery center ID, and a special service number which is an article ID when a large quantity of articles for special service is received after previously classifying. If the large quantity of articles for special service is not classified previously, the receipt information is not required. Therefore, the auto-processing system includes a function for minimizing searching objects in auto-classification by removing receipt information from delivery information through comparing the delivery information created by manual process and the receipt information in the auto-processing system.

The present invention is characterized by including a step for creating delivery information that includes an operation for removing the faulty classified mail by reading the barcode thereof in case of checking whether mails are faulty classified or not before or after packaging classified mails, or for transiting the driving mode of the supplying unit in classification equipment to “faulty classifying result removing mode’ and automatically removing faulty classification ID by reading a barcode of a faulty classified mail in case of a large quantity of mails are faulty classified.

The auto-processing system according to the present invention also includes an operation for recording destination information of a packaging box or a pallet (or roll container) for classified articles at a RFID tag or attaching a barcode label that is previously printed by classification sections in order to certify a packaging state of articles, and detecting whether any articles are missed by comparing the weight of the packaging box filed with mails and total weight in the receipt information. The auto-processing method according to the present invention also includes a step for transferring postcode information to a corresponding distribution center to be corresponding to a major customer ID or an article ID when a returned or replied article is received, and a step for automatically classifying articles into a return section and a reply section according to a result of reading a return mark and a reply mark and creating delivery information thereof.

That is, the present invention is to automatically process articles for providing a special service, which are manually processed by a conventional system and method. Since the auto sort is possible when a small quantity of receipt information is accessed and the auto sort is impossible when network becomes malfunctioned in POSTNET in an auto-processing system that automatically classifies a receipt information file in real time, the receipt information is transferred before the articles are arrived at the receipt information matching system of each distribution center, the receipt information is transformed to an appropriate structure to search in high speed in the auto-processing system, and a large quantity of receipt information is automatically processed by configuring the system to remove the receipt information using the result of the auto-processing.

Hereinafter, the configuration of the present invention and a method thereof will be described in detail.

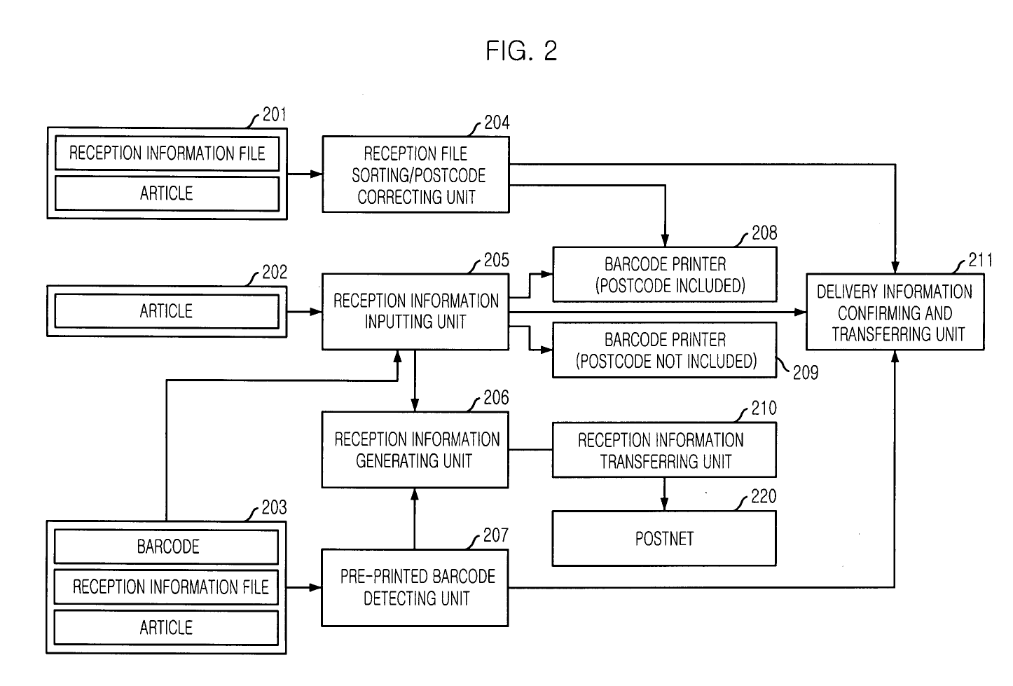

FIG. 2 is a block diagram illustrating the reception system shown in FIG. 1.

As shown in FIG. 2, the reception systems 111, 120, 151 and 160 of the system for automatically processing articles according to the present embodiment include a plurality of articles and reception information 201, 202 and 203 from a customer, and process the received articles according to the reception information.

Each of the reception systems 111, 120, 151 and 160 includes a reception file sorting/postcode correcting unit 204, a reception information inputting unit 205, a reception information generating unit 206, a pre-printed barcode detecting unit 207, barcode printers 208 and 209, and a delivery information generating result confirming and transferring unit 211. The reception file sorting/postcode correcting unit 204 receives a plurality of articles and a reception information file, inspects the reception information file, and correct wrong postcodes. The reception information inputting unit 205 receives articles from the customer and input the reception information. The reception information generating unit 206 creates reception information by combining the input information from the reception information inputting unit 205 and the postcode. The pre-printed barcode detecting unit 207 detects a case that a postcode is present at the reception file of the articles received from the customer and a postcode is not present at a barcode. The reception information transferring unit 210 transfers the created reception information at the reception information generating unit 206 to the POSTNET 220. The barcode printers 208 and 209 print a barcode to be attached at the article. The delivery information confirming and transferring unit 211 confirms and delivers created delivery information.

If a plurality of articles and reception information file 201 are received from a customer, the reception information file is inspected to determine whether a postcode is correct or not. If the postcode is wrongly used, the reception information file sorting/postcode correcting unit 204 corrects the wrong postcode. Then, the barcode printer 208 prints a barcode with a postcode included and the printed barcode is attached at a corresponding article.

When an article 202 is received individually, the article 202 is processed through the delivery information confirming and transferring unit 211 by inputting the information of mail through the reception information inputting unit 205 and printing a barcode with a postcode included by the barcode printer 208. Herein, if a number of articles are received, the articles are received by printing a barcode with a reception office number and an unique number of an article and without a postcode through the barcode printer 209, and the received articles are processed through the delivery information confirming and transferring unit 211.

Meanwhile, in case of receiving an article 202 having a barcode without a postcode included, and in case of receiving an article 203 with a pre-given barcode with a postcode, the articles 202 and 203 are sorted as an article without a barcode. If a postcode is not present, a postcode is inputted through the reception information inputting unit 205 at a reception desk based on a postcode printed at each mail, or a single record is created with a reception office number or a customer number, an article ID number and a postcode using the reception information file.

That is, in case of an article having a barcode with an ID number thereof, the postcode inputted at a reception system, a corresponding reception office number and an ID number of the article are stored in data fields and transferred to the reception information generating unit 206. If a number of articles having barcodes without postcodes included are received although the reception information file include the postcodes, the method of composing the pre-give barcode is detected by the pre-printed barcode detecting unit 207 and the detecting result is transmitted to the POSTNET 220 through the reception information generating unit 206 and the reception information transferring unit 210.

Since the articles are very diverse, the reception information may include a weight and a data of receiving.

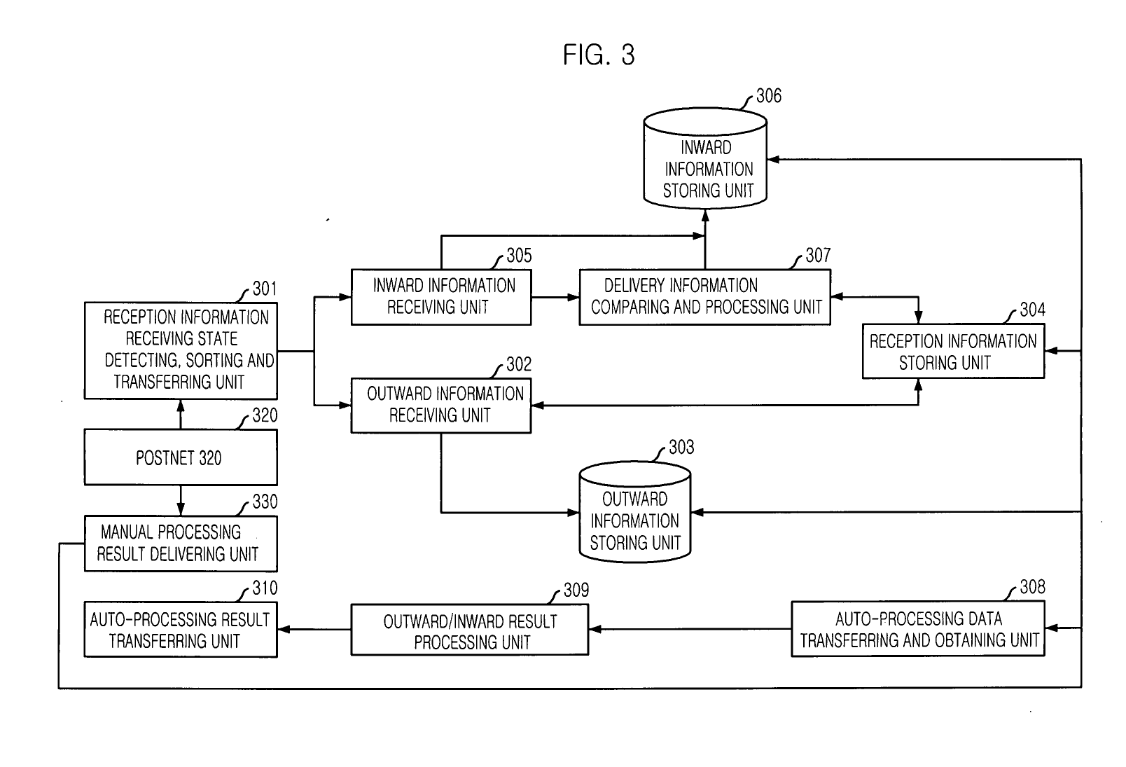

FIG. 3 is a block diagram illustrating the reception information matching system shown in FIG. 1.

After the POSTNET 320 receives the reception information from the reception systems 111, 120, 151 and 160, the POSTNET 320 sorts the reception information into inward information and delivery information and transfers the sorted information to each of the distribution centers.

As shown in FIG. 3, the reception information matching system includes a reception information receiving state detecting, sorting and transferring unit 301, a outward information receiving unit 302, a outward information storing unit 303, a reception information storing unit 304, an inward information receiving unit 305, an inward information storing unit 306, a delivery information comparing and processing unit 307, an auto-processing data transferring and obtaining unit 308, an outward/inward result processing unit 309, an auto-processing result transferring unit 310, a POSTNET 320 and a manual processing result delivering unit 310. The reception information receiving state detecting, sorting and transferring unit 301 receives the reception information from the POSTNET 320, sorts articles into a small article, a large article and a parcel based on the reception information of the article, sorts the reception information into outward information and inward information, and transfers the sorted information. The inward information receiving unit 305 receives the inward information from the reception information receiving state detecting, sorting and transferring unit 301. The outward information receiving unit 302 receives the outward information from the reception information receiving state detecting, sorting and transferring unit 301. The delivery information comparing and processing unit 307 determines whether reception information received from the inward information receiving unit 305 is delivery information or not. The inward information storing unit 306 stores the inward information. The outward information storing unit 303 stores the outward information. The reception information storing unit 304 sorts the reception information and unsorted information. The auto-processing data transferring and obtaining unit 308 transfers the sorted reception information to the auto-processing system in order to enable the auto-processing system to store the sorted reception information. The outward/inward result processing unit 309 transforms the delivery information into a predetermined data format to be transmitted to the POSTNET 320 when the delivery information is received as a result of sorting and processing, and prepares for transmitting the transformed delivery information to a mobile server in a distribution center. The auto-processing result transferring unit 310 transmits delivery information after confirming an assigned time to transfer delivery information which is a result of processing the outward information processing unit 303 and a connecting state of the POSNET 320 for transferring the delivery information.

The reception information matching system according to the present embodiment may receive the inward and outward information without sorting them. In this case, one of the outward information receiving unit and the inward information receiving unit is used normally.

When the reception information receiving state detecting, sorting and transferring unit 301 receives the reception information transferred from the POSTNET 320, articles are sorted into a small article, a large article and a parcel based on the reception information, and the sorted articles are transferred to a corresponding auto-processing system. Herein, the reception information receiving state detecting, sorting and transferring unit 301 performs a step for previously sorting the reception information based on specification, an article ID number and a weight included in the reception data in order to sort the reception information for the small article, a step for checking a type of logistics as necessary reception information when a logistics start number and a last number for a pre-given barcode logistics are received from a reception system, sorting reception information into outward information and inward information, and storing and storing logistics by the ID numbers of a reception office or a customer, and a step for storing the received reception information into the inward information when the received reception information is not distinguished by outward information and inward information and sorting the received reception information into the delivery information when it is not corresponding to the postcode of a corresponding delivering office. Also, the reception information receiving state detecting, sorting and transferring unit 301 may use a method for storing inward information, outward information, specification, weight and a pre-given barcode without sorting them. Meanwhile, the reception information may be sorted into the inward information and the delivery information as the result of processing and the inward information receiving unit 305 and the delivery information receiving unit 301 may receive the inward information and the delivery information, respectively.

When sorting and storing are not required, the reception information receiving state detecting, sorting and transferring unit 301 may selectively use a function for transferring the reception information to the delivery information receiving unit only.

If the reception information is determined as delivery information by checking the flag of the received reception information, the inward information receiving unit 305 receives the inward information, and the delivery information comparing unit 307 checks whether the received information is the delivery information or not.

If the delivery information comparing unit 307 determines that the received information is the delivery information, the delivery information comparing unit 307 performs a step for using a reception office ID number or a customer ID number, a logistics ID number and a postcode as one field among inward information fields, and replacing received data to delivery information by comparing the stored data as the inward information and a matched part thereof.

Based on the result, if inward information not processed by the auto-processing system is present at the inward information storing unit 306, the reception information sorting unit 304 sorts the reception information to align the reception information with the not processed reception information.

Meanwhile, the auto-processing data transferring/obtaining unit 308 transfers the sorted reception information to the auto-processing system to store them. At the same time, the auto processing data transferring/obtaining unit 308 receives IDs of reception information, which is a result of sorting, from the auto-processing system and a process completion flag, and transfers the received result to the reception information sorting unit 304. Herein, the reception information sorting unit 304 receives the result, and removes inward information and delivery information stored in the storing unit using the received data as the result of processing the auto-processing system.

The outward/inward result processing 309 transforms the delivery information into a data format to transfer to the POSTNET 320 when the delivery information is received as the sorting result and prepares for transferring the transformed delivery information to a mobile server in a logistics center. For example, the 309 generates logistics center ID, the number of delivery information, a time for completing a process, and target object ID.

The auto-processing result transferring unit 310 checks a time assigned to transfer the delivery information which is a result of the outward/inward result processing 309 and the connection state of the POSTNET 320 for transferring the delivery information. Then, the auto-processing result transferring unit 310 transfers the delivery information.

Meanwhile, the reception information sorting unit 304 removes the result of sorting the inward information and the delivery information by the delivery information comparing unit 307 from the delivery information storing unit 303 and the inward information storing unit 306 in order to search and remove unnecessary reception information from the delivery information 330 as the manual process. Also, the reception information may be regularly removed at a regular interval.

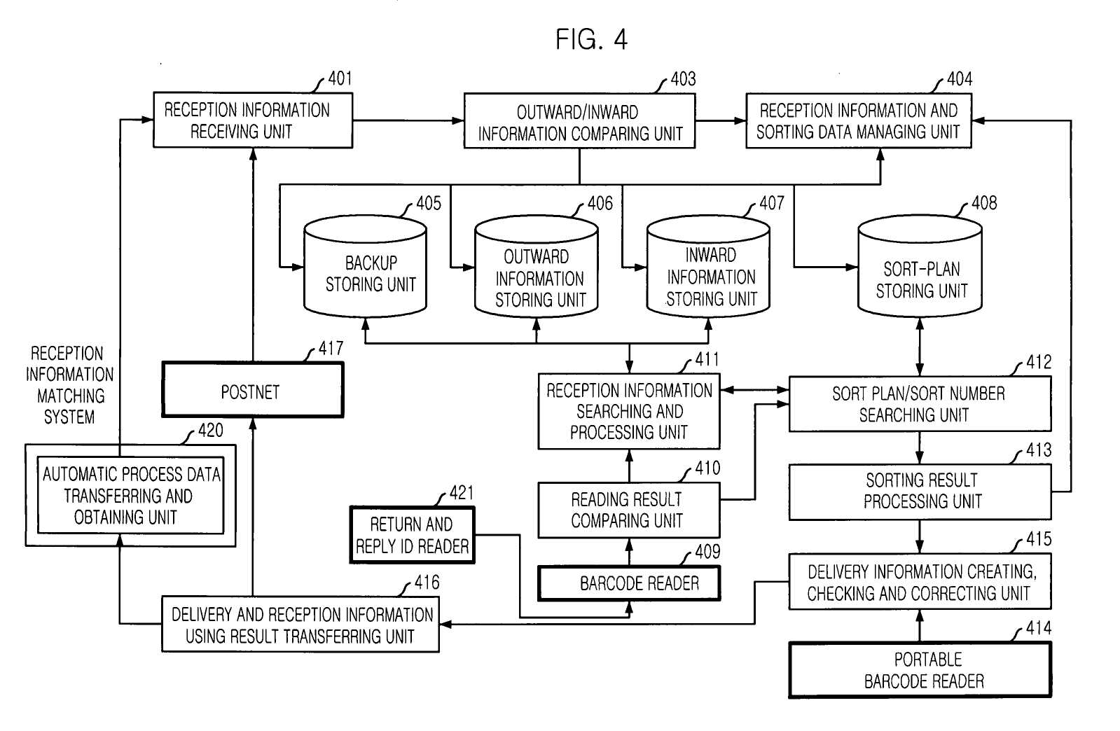

FIG. 4 is a block diagram illustrating an auto sorting and delivery information generating system of FIG. 1. With reference to FIG. 4, a step for receiving reception information as data used to sort, a step for sorting and storing the reception information, and a step for automatically sorting through high speed searching result and creating delivery information when a postcode is not present after reading a barcode attached on logistics are described.

As shown in FIG. 4, the auto sorting and delivery information creating system includes a reception information receiving unit 401, a outward/inward information comparing unit 403, a reception information and sorting plan data managing unit 404, a backup storing unit 405, a outward information storing unit 406, an inward information storing unit 407, a sort-plan storing unit 408, a barcode reader, a reading result comparing unit 410, a reception information searching and processing unit 411, a sort plan/sort number searching unit 412, a sorting result processing unit 413, a portable barcode reader 414, a delivery information creating, checking and correcting unit 415, a delivery and reception information using result transferring unit 416, a POSTNET 417, and an automatic process data transferring and obtaining unit 420. The reception information receiving unit 401 receives reception information by the automatic process data transferring and obtaining unit 420. The outward/inward information comparing unit 403 sorts reception information from the reception information receiving unit 401 into inward information and outward information and compares the inward information and the outward information. The reception information and sorting plan data managing unit 404 separates the compared data from the outward/inward information comparing unit 403 into the outward information and the inward information, and manages the outward information and the inward information. The outward information storing unit 406 for storing the outward information separated at the reception information and sorting data managing unit 404. The inward information storing unit 407 stores the inward information separated at the reception information and sorting data managing unit 404. The sort-plan storing unit 408 stores information about logistics sorting sections. The backup storing unit 405 backs up the outward information storing unit 406, the inward information storing unit 407 and the sort-plan storing unit 408 and stores the backed up data. The barcode reader 409 reads a barcode of a logistics supplied to be automatically processed. The reading result comparing unit 410 determines whether a postcode is included or not based on the reading result from the barcode reader 409. The sort-plan/sort number searching unit 412 sets a plan for inward and outward sorting corresponding to a postcode when the postcode is present at the barcode. The sorting result processing unit 413 transfers the information of corresponding sorting section into a corresponding sorting section as a result obtained by searching the sort-plan storing unit 408 according to the result of the sort-plan/sort number searching unit 412. The reception information searching and processing unit 411 searches reception information at the outward information storing unit 406, the inward information storing unit 407 and the sort-plan storing unit 408. The delivery information creating, checking and correcting unit 415 creates the delivery information as a processing result of the 413, inspects the delivery information and corrects the delivery information. The delivery and reception information using result transferring unit 416 transfers the reception information marking result and the delivery information to the automatic process data transferring and obtaining unit 420 and the POSTNET 417. The return and reply ID reader 421 recognizes the return/reply ID on the articles.

When the reception information receiving unit 401 receives the reception information by the auto processing data transferring and obtaining unit 420, the outward/inward information comprising unit 403 compares the inward information and the outward information and transfers the comparing result to the reception information and sorting data managing unit 404. While transferring, the data of a corresponding outward information storing unit 406 and inward information storing unit 407 is stored in the backup storing unit 405.

The reception information and sorting data managing unit 404 stores the received outward information at the outward information storing unit 406 and the inward information storing unit 407 by ID numbers of a reception office and a customer. Also, the reception information and sorting data managing unit 404 may occasionally store the received outward information at the outward information storing unit only without sorting the outward information and the inward information and using detail sorting codes.

The sorting result processing unit 413 confirms the result of setting a outward/inward sort-plan by transferring barcode information obtained at the reception information searching and processing unit 411 when the reading result comparing unit 410 determines that a postcode is not present. The storing result processing unit 413 searches the number of a sorting section for a sort-plan, which is matched with a keyword such as the ID number of the reception office or the customer, from the outward information storing unit 406 and the inward information storing unit 407. The articles are delivered to the corresponding sorting sections according to the obtained result.

Meanwhile, if a postcode is present in the searched result from the reception information searching and processing unit 411, a read marking step is included. The result of sorting is temporally stored in the backup storing unit 405. Also, if a postcode is present at a barcode, the reading result is temporally stored at the backup storing unit 405 through the reception information and storing data managing unit 404.

Meanwhile, the delivery information creating, checking and correcting unit 415 creates the delivery information of a sorting section based on a reading barcode result from the portable barcode reader 414 and the sorting result stored in the backup storing unit 405. Herein, the reading barcode result from the portable barcode reader 414 is a result of reading a barcode with a sorting section ID number, which was attached at a corresponding sorting section, a barcode attached at the first article in an order of stacking articles, a barcode attached at the last article, and a barcode including a sorting section ID number, a distribution center ID number and a processing order number attached at a box. The delivery information creating, checking and correcting unit 415 compares an article's weight recorded in the reception information and a real weight measured by subtracting the weight of the container, and determines whether the comparing result is in an error-allowable range in order to check the reliability of the delivery information. If the comparing result is in the error-allowable range, the delivery information creating, checking and correcting unit 415 determines whether the delivery information is normally created or not. Also, if the compared weights are not matched, an error message is displayed at an operator's portable terminal. Than, the delivery information creating, checking and correcting unit 415 re-checks the article in the container and corrects a wrongly loaded article or omitted information by a manual process.

The delivery information creating, checking and correcting unit 415 checks wrongly-sorted mails before or after assembling sorted mails and removes the registered barcode of the wrongly-sorted mails. Also, when many wrongly-sorted mails are detected, the delivery information creating, checking and correcting unit 415 changes the driving mode of the sorted mail supplying unit into a wrongly-sorting result removing mode. Furthermore, the delivery information creating, checking and correcting unit 415 reads the registered barcode of the wrongly-sorted mail when a wrongly-sorted mail is supplied and automatically removes the registered number of the wrongly-stored mail.

The delivery and reception information using result transferring unit 416 transfers the delivery information to a G/W reception information server in a distribution center in order to transfer the delivery information to the POSTNET 417. The delivery and reception information using result transferring unit 416 transfers a history of using the reception information to the automatic process data transferring and obtaining unit 420 so as to remove the used reception information.

Meanwhile, when return and replay information are received, operations for transferring articles to a distribution center by sorting into a outward and inward sorting operation are performed as described in FIGS. 2 and 4. If a return and replay mark is present at an article, the return and replay mark is read using the return and reply ID reader 421 and it is processed by finding a sender's postcode, automatically sorting and creating delivery information. If the return and replay mark is not present, it is automatically processed based on a receiver's postcode.

Additionally, when a corresponding section is overflowed during sorting, the read mark of the used reception information is released, and the result of sorting is not temporally stored in the backup storing unit 401 so as to improve the accuracy of the delivery information.

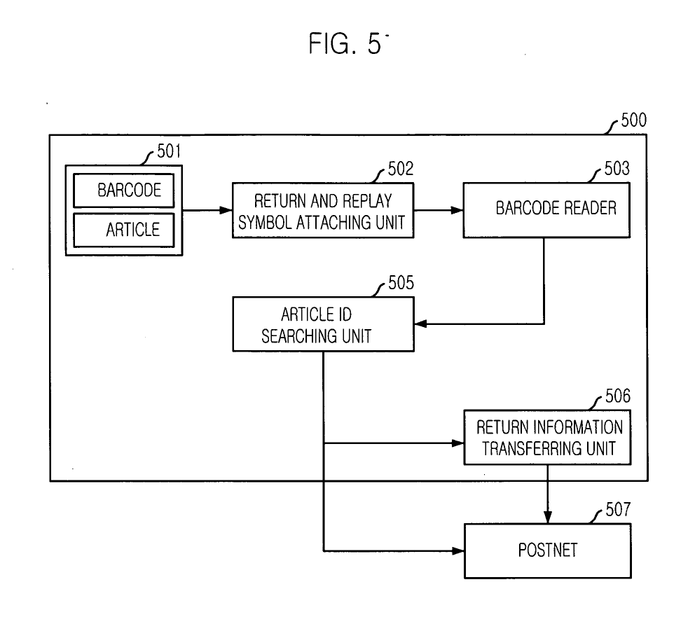

FIG. 5 is a block diagram illustrating the return and reply information processing and transferring system shown in FIG. 1 for describing a step for receiving and processing a returned and replying article.

As shown in FIG. 5, the return and reply information processing and transferring system according to the present embodiment includes a return and replay symbol attaching unit 502, a barcode reader 503, an article ID searching unit 505, and a return information transferring unit 506. The return and replay symbol attaching unit 502 attaches a return and reply symbol at a predetermined location of a returned or replying article 501. The barcode reader 503 reads a barcode attached by the return and replay symbol attaching unit 502. The article ID searching unit 505 searches a sender's postcode from POSTNET 507 based on the read barcode. The return information transferring unit 506 registers the searched information from the article ID searching unit 505 as a returning information and transfers the returning information to the POSTNET 507.

If the returned or replying article 501 occurs during delivering, a return and replying symbol such as a sticker is attached at a predetermined location of the article. Then, the article barcode is read and a sender's postcode is searched from the POSTNET 507 using the read barcode information. Then, it is registered as returning information and the returning information is transferred to the POSTNET 507 so as to create information that enables the returning and replying article to be automatically processed.

The result uses reception information and a sane transferring method. But, a sender's postcode is included. In case of article for a personal customer, the postcodes of reception offices or senders can be used through registering.

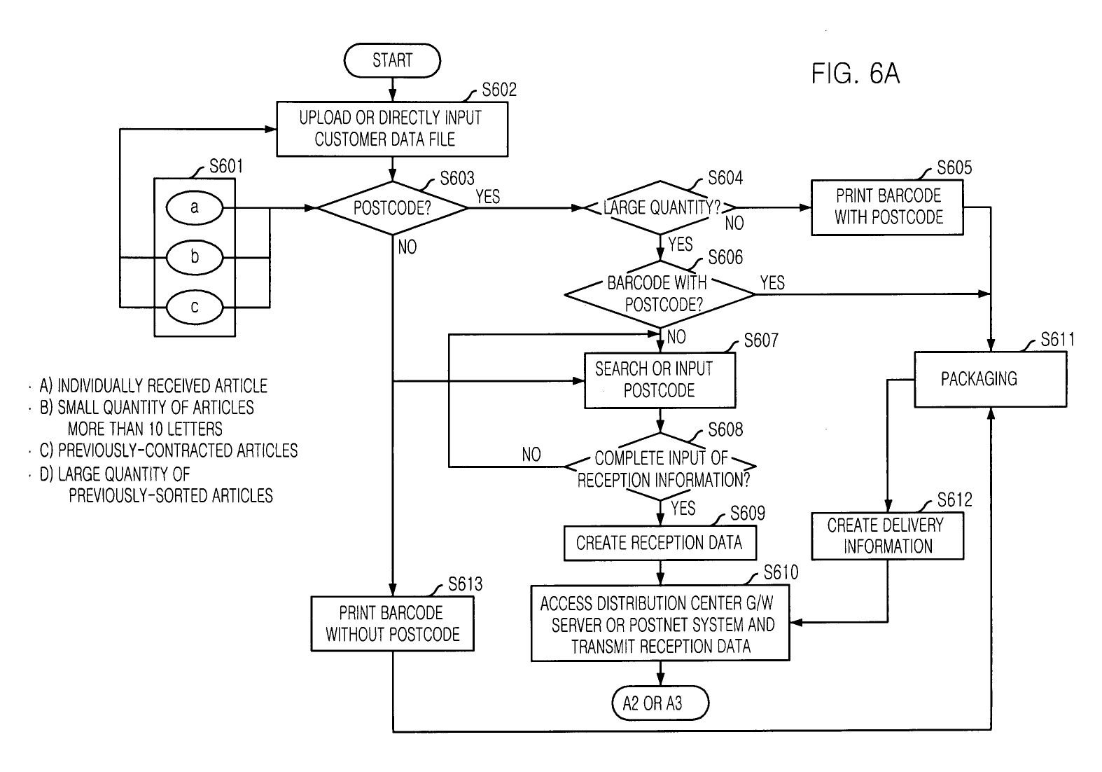

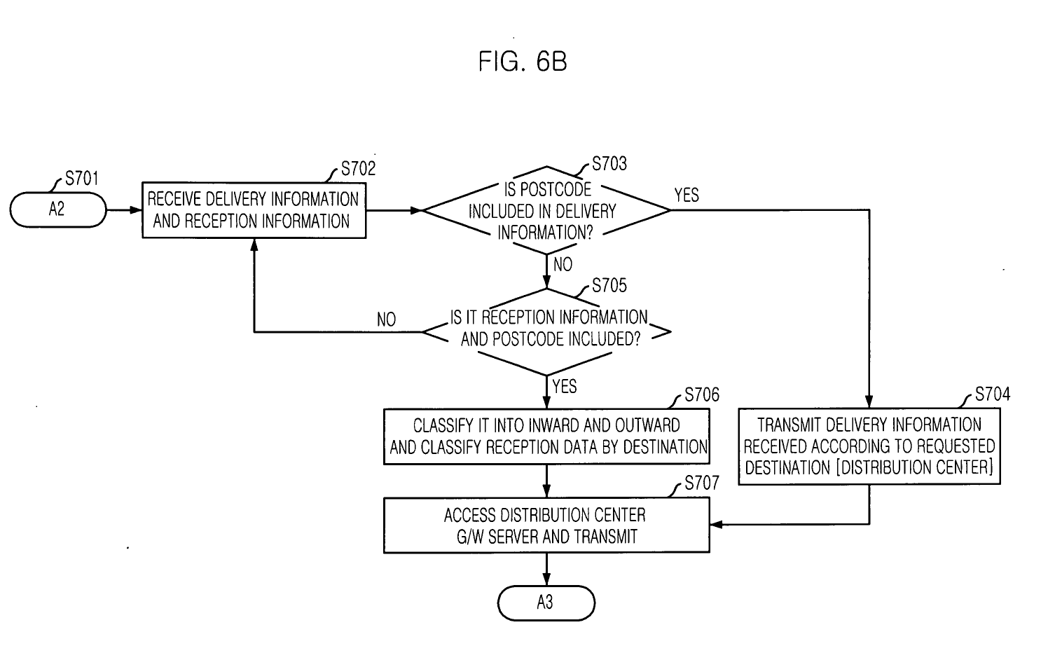

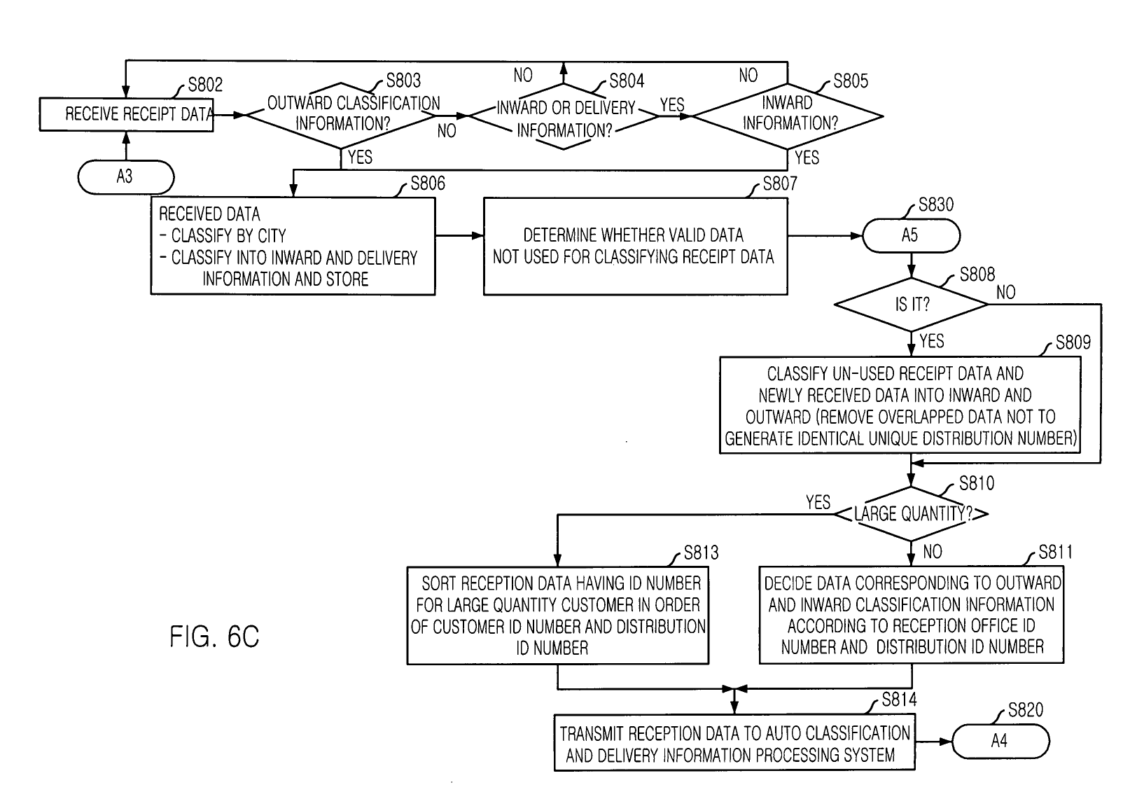

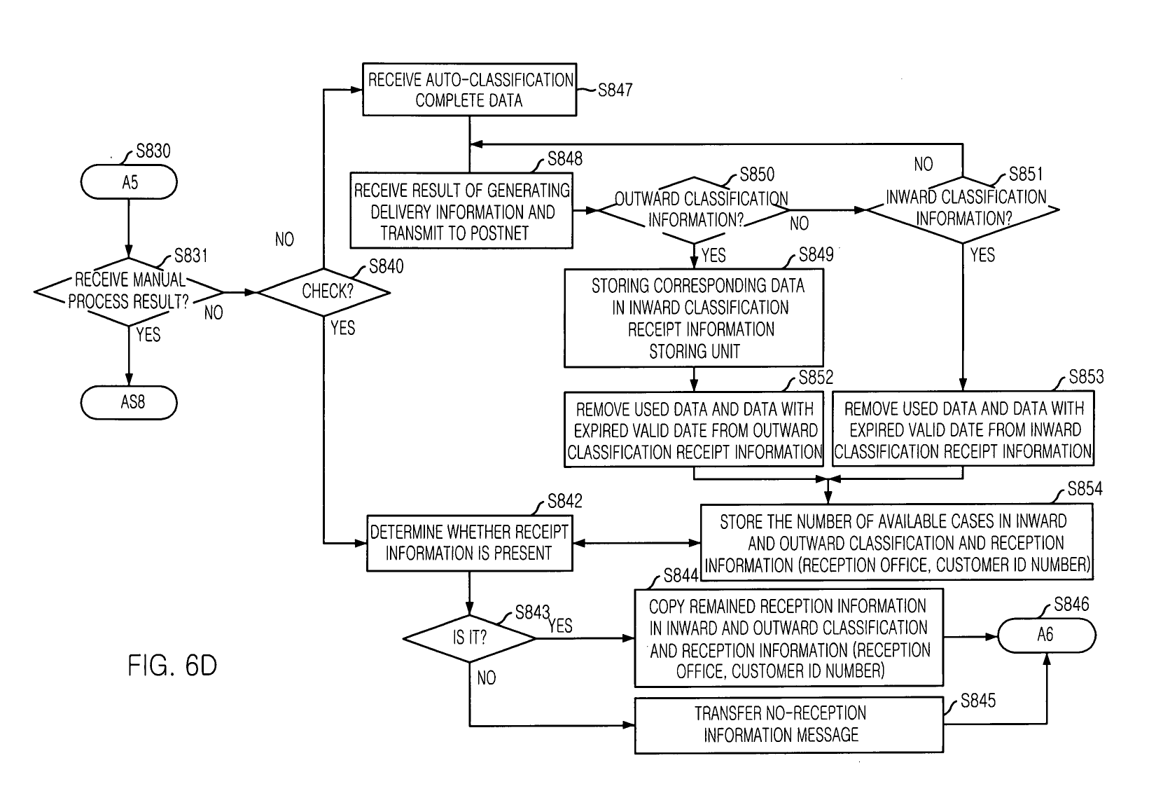

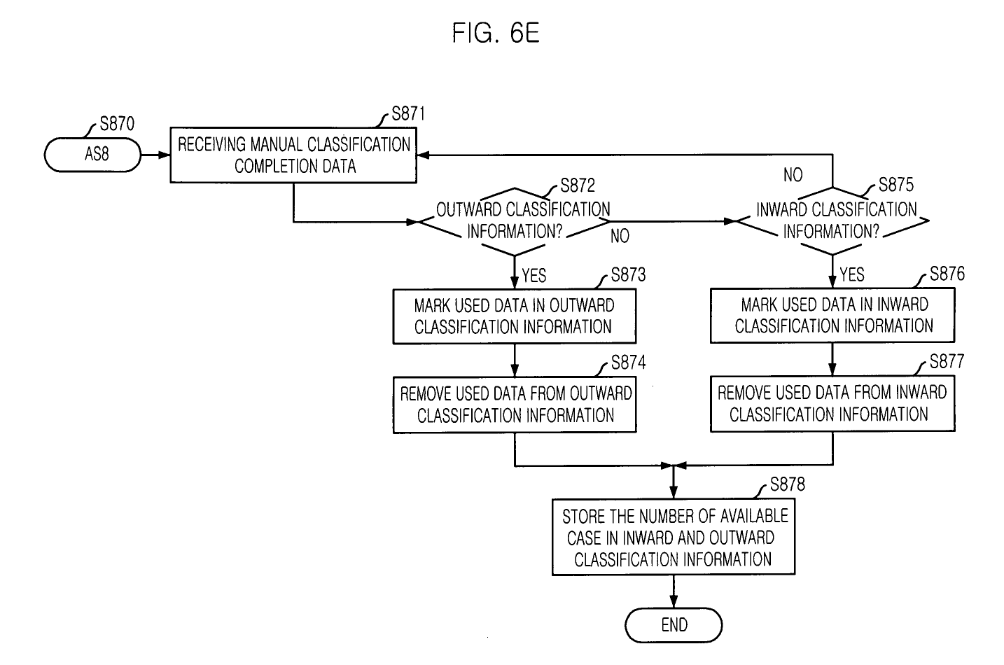

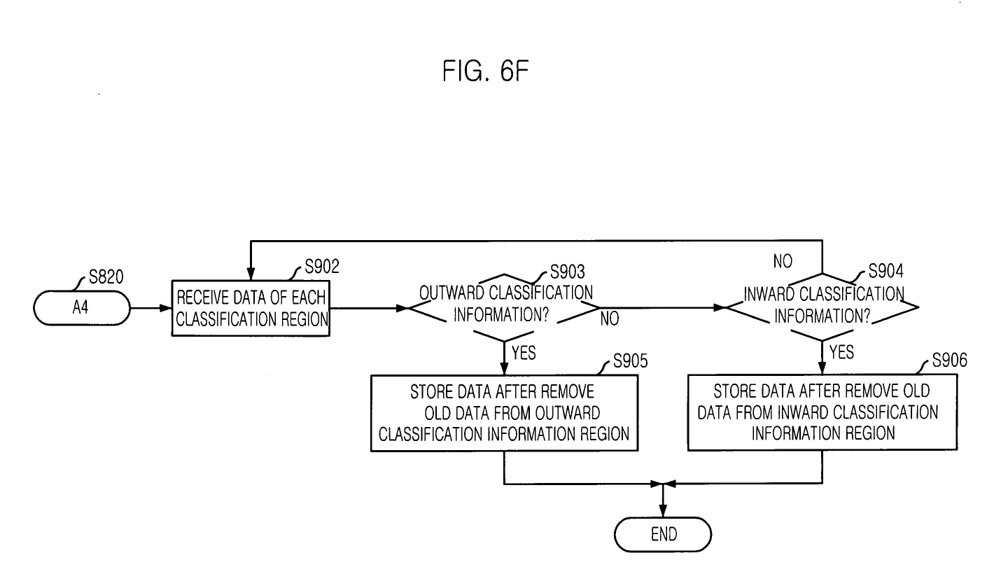

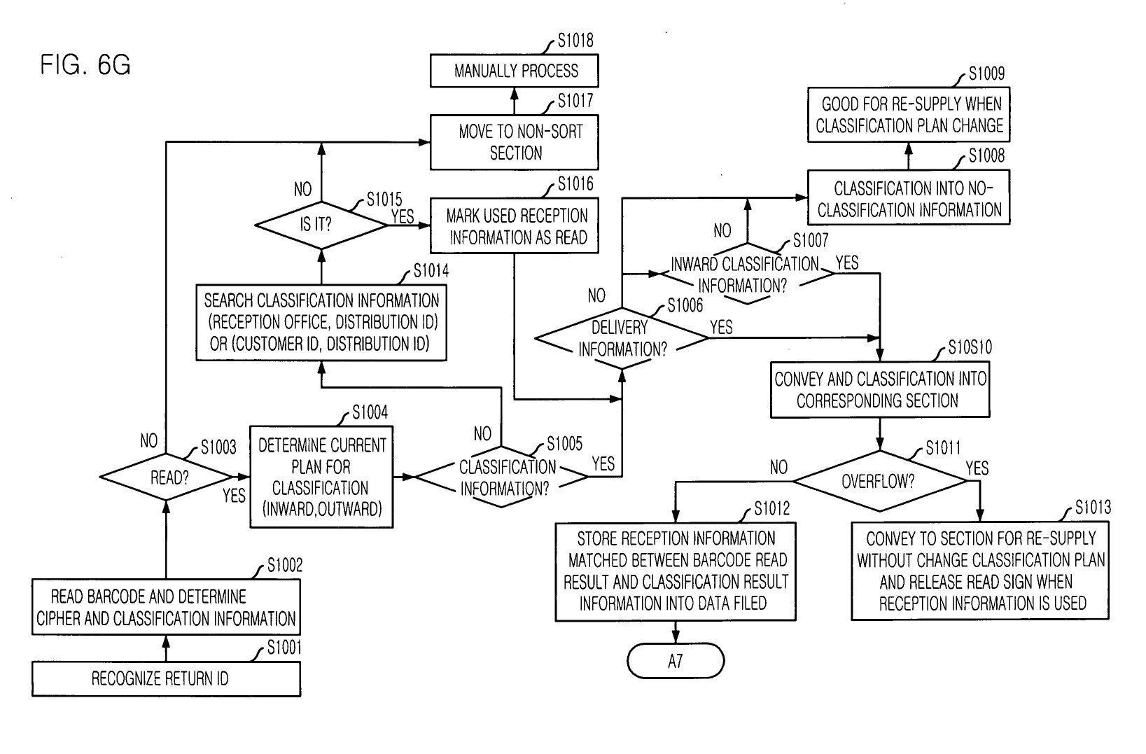

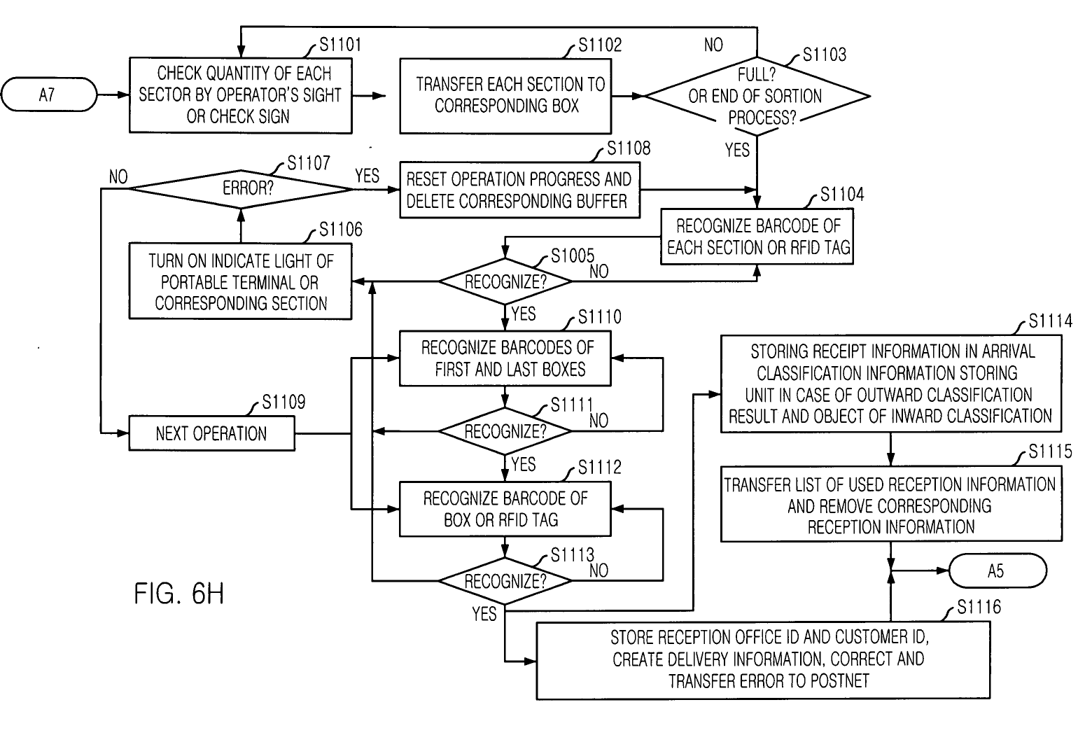

FIGS. 6A to 6H are flowcharts illustrating a method for automatically processing articles for a special delivery service in accordance with an embodiment of the present invention.

The method for automatically processing articles for a special delivery service according to the present embodiment includes the steps of a) receiving articles for a special delivery service, and transferring reception information an delivery information which is shown in FIG. 6A, b) distributing the created reception information at the POSTNET which is shown in FIG. 6B, c) matching the reception information transferred from the POSTNET at the reception information matching system at the distribution center, sorting the matched information and transferring the sorted information which is shown in FIG. 6C, d) removing the reception information which is used for auto-sorting and creating delivery information at the reception information matching system, which is shown in FIG. 6D, e) removing unnecessary information using a result of manual process at the reception information matching system of the distribution center which is shown in FIG. 6E, f) storing the received reception information for auto sort, which is shown in FIG. 6F, g) auto sorting returns and replies among the articles for the special delivery service, which is shown in FIG. 6g, and h) creating delivery information using the result of auto-classification and process of the articles for a special delivery service.

FIG. 6A is a flowchart for describing a method for receiving an article for a special delivering service and transferring reception information and delivery information in accordance with an embodiment of the present invention.

Hereinafter, the step for receiving an article for a special delivering service and transferring reception information and delivery information in accordance with an embodiment of the present invention will be described.

At first, a customer data file for a received article is uploaded or is directly inputted at step S602. Then, it determines whether a postcode is present or not at step S603.

If the postcode is not present at step S603, a barcode without a postcode included is printed at step S613 and the barcode is attached the container for the corresponding article at step S611. Then, the delivery information is created at step S612 and the created delivery information is transmitted by accessing the distribution center gateway server or the POSTNET at step S610.

If the postcode in present at step S604, it determines whether it is a large quantity of articles or not at step S604. If it is not a large quantity of articles, a barcode with a postcode is printed at step S605 and attached and loaded at the container thereof at step S611. If it is the large quantity of articles, it determines whether a barcode with a postcode included is present or not at step S606.

If the barcode with a postcode is present at step S606, the barcode is attached at the container thereof at step S611. If the barcode with a postcode is not present at step S606, a postcode is searched or is directly inputted at step S607. Then, it determines whether the reception information is completely inputted at step S608, and the reception data is created at step S609. The created reception data is transmitted by accessing the distribution center gateway server or the POSTNET.

The received articles 601 are classified into a case a) individually received article, a case b) small quantity of articles more than 10 letters, a case c) previously-contracted articles and a case d) large quantity of previously-sorted articles. Herein, the case b) the small quantity of articles is a case of no postcode and reception file at the reception information, and the case C) the previously-contracted article is a case of receiving an article by printing a barcode with a postcode or reception information is present without postcode.

In case of the few articles which are less than 10, information about a receiver and a sender is inputted to a reception information system, the postcode of the receiver is present, and a barcode is printed with a postcode included. If the postcode cannot be included, the barcode is printed without the postcode included, and the printed barcode is attached to the article. At a reception office, a postcode is directly inputted before the article is delivered from the reception office to other office, and reception information is created before a closing time of performing an operation or delivering articles when the input is completed. The created reception information is transferred to the POSTNET or the gateway server of a corresponding distribution center. The real article is packaged with a container, delivery information is created by reading a barcode attached at the container, and the created delivery information is transferred to the POSTNET.

In case of a large quantity of mail, a postcode may not be applied because a pre-given barcode may be given to a customer. In this case, reception information is transferred using file information that is filed when the article is registered. That is, it detects whether the postcode of the article is included in a barcode or not, and it determines whether a receiver's postcode is recorded in the reception file or not. If the postcode is included in the reception file and the large quantity of articles are registered, it determines whether a postcode is included in a barcode or not. If the postcode is in the barcode, the articles are arranged to be packaged with a packaging box. If not, it creates necessary information for auto-processing through matching reception information such as a postcode, and an article ID in a custom data reception file. After the receipt information processing, the reception data is created. The result of creating the reception data is transferred to a gateway server (G/W), a POSTNET. Then, the articles are packaged with a box, delivery information is created and transferred to the POSTNET so as to transfer taking-over information and the receipt information to be used for auto sort.

The transferred receipt information includes a data of receiving, a type of article, an article ID or a custom ID, a weight, and a receiver's postcode.

When the large quantities of articles are registered, the articles are classified by a distribution center or a postcode, and an article barcode ID is included without a postcode, the receipt information is created as described above. However, when the postcode is not included, the receipt information is not created.

FIG. 6B is a flowchart illustrating a step of distributing reception information in a method for automatically processing articles for a special delivery service.

Referring to FIG. 6B, delivery information and reception information, which are transmitted by a reception office or a reception system of a distribution center, are received at step S702, and it determines whether a postcode is included in the received delivery information or not at step S703.

If the received delivery information includes the postcode for sorting according to a corresponding distribution center and transmitting to the corresponding distribution center, the delivery information is transmitted to the corresponding distribution center at step S704. If the postcode is not included at step S703, it determines whether it is reception information and a postcode is included or not at step S705. Then, the reception information is sorted into the inward and delivery information and is sorted by a destination at step S706. Then, the sorting result is transmitted by accessing a distribution center gateway (G/W) server at step S707.

When the reception information such as returning/replying information is received, all of the received information is transmitted to a corresponding distribution center, or the received information is sorted and gradually transmitted to the gateway server of a distribution center.

FIG. 6C is a flowchart illustrating a step for sorting and transferring reception information for matching reception information in accordance with a preferred embodiment of the present invention.

Referring to FIG. 6C, reception data transmitted to a distribution center is received at step S802. Then, it determined whether the reception data is outward-sorting information or not at step S803, whether the reception data is inward or delivery information at step S804, and whether the reception data is outward-sorting information at step S805. Then, the received reception information is classified by type, inward, and delivery information at step S806. Then, it determines whether valid data, which is not used, is present among the reception data or not at steps S807 and S808.

If the valid data is not present at step S808, it determines whether a received article is a quantity of articles or not at step S810. If it is the quantity of articles, the reception data having a major customer's ID number is sorted by a customer ID number and an article ID number at step S813. Then, the reception data is transmitted to the auto sorting and delivery information processing system at step S814.

After checking the result at step S810, if it is not a quantity of articles, data of outward and inward sorting information is sorted by a reception office ID number and an article ID number at step S814.

If the valid data is present at step S808, it sorts and combines un-used information and newly received data at step S809, and the step 810 is performed to determine whether it is a large quantity of articles or not. Herein, overlapped data is removed not to generate the same article ID number.

After receiving the reception data, it determines whether the reception data is transferred for outward classification. If not, it determines whether the reception data is delivery information for inward classification or not. If it is the delivery information for the inward classification, the delivery information is stored in a temporal storing unit in order to use a postcode combined with an article ID in the delivery information. If the received data is the receipt information for inward classification, the received data is stored in an inward classification storing unit by the types of articles. If the received data is receipt information for outward classification, the received data is classified and stored in the inward classification storing unit. In these described steps, it determines whether a receiver's postcode is matched with a delivery office postcode of a corresponding distribution center or not in order to classify and store articles that are not classified into the outward or the inward classification. If the postcodes are matched, the articles are classified into the inward classification. If not, the articles are classified into the outward classification. In order to selectively store the reception data without classifying it into outward and inward, predetermined steps in the steps of S806, S809, S811, and S813 may be omitted to perform.

If there is previously received receipt information, the previously-received receipt information is combined with the newly-received receipt information in a unit of inward or outward classification information. If it is not large quantity mail receipt information, the inward and the outward classification data of the received receipt information are sorted by a reception office and an article ID. If the receipt information is for a large quantity of articles and includes a pre-give barcode, the receipt information is sorted by the article ID in a customer ID unit and stored into an inward and an outward classification storing units. Then, the receipt information is transferred to a corresponding data storing unit in the auto sort and delivery information processing system.

FIG. 6D is a flowchart showing a step for detecting whether valid data is in used receipt information and a step for removing receipt information used for auto sort and delivery information creation in accordance with an embodiment of the present invention.

Referring to FIG. 6D, it determines whether a result of manual processing is received or not, whether a result of auto sort is received or not, or whether receipt information is present or not at steps S831 and S840.

If it requires to determine whether residual receipt information is present without receiving the result of manual processing at steps S831 and S840, the history of sorting results is inspected at step S854 to determine whether usable receipt information is present or not at step S842. If the useable receipt information is present, residual receipt information is copied from the inward and outward classification receipt information at step S844, a result of requesting to detect validity of the receipt information is stored, and the result of storing for the request result is noticed at step S846. If the usable receipt information is not present, a message for no receipt information is transferred at step S845.

Auto-classification completion data is received with the detecting results from the steps S831 and S840, and the result of using the receipt information by the auto-processing system at step S847, and the result of creating delivery information is received, and transferred to the POSTNET at step S848. After transferring, it determined whether the receipt information included in the used delivery information is inward classification information or outward classification information at steps S850, and S851.

If it is the outward classification information at steps S850 and S851, the classification process is completed as the outward classification receipt information. If it is the inward classification object, corresponding data is stored in an inward classification receipt information storing unit at step S849. Data with expired valid data is removed at step S852 after using the outward classification receipt information.

If it is the inward classification information at steps S850 and S851, used data and data with expired valid period are removed from the inward classification receipt information at step S853.

After removing the used data and the data with expired period at step S852 and S853, the history of residual available data from the inward and outward classification information is stored at step S854.

Meanwhile, in case of an article to perform the inward classification at a same distribution center although the outward classification is completed, the receipt information of the outward classification storing unit is removed and it is added as inward classification receipt information at step S849.

FIG. 6E is a flowchart showing a step for removing information through receipt information at an auto-processing system through a function to remove article IDs of processed articles for a large quantity of articles or an individually registered article in accordance with an embodiment of the present invention.

After manually classifying the articles or creating the delivery information thereof, a manual process classification and delivery information creation completion data is received by a receipt information matching system. If it is the result of manual process at step S831, a manual process completion data is received at step S871. Then, a result of performing is classified by determining whether the manual classification completion data is outward classification information or inward classification information at step S872 and S875, and the used data is marked from the outward classification receipt information by finding identical article ID at step S873. Also, a used data is marked from the inward classification receipt information at step S876.

Afterward, receipt information marked as used is removed from the outward and the inward classification receipt information after searching all delivery information at steps S874 and S877. As a result of performing, the searched quantity, the number of removed receipt information, the number of residual receipt information, reception offices used by inward and outward classification receipt information and the number of usable customer IDs are stored at step S878. It controls to transfer minimum receipt information to an auto-processing system by combining newly-received receipt information and previously-received receipt information.

The storing result of the step S878 uses the same information storing unit used in the step S854 when the auto-classification completion data is received at step S847 in order to sustain the consistency of checking residual receipt information.

FIG. 6F is a flowchart showing a step for storing received receipt information for auto-classification in accordance with an embodiment of the present invention.

At step S902, the data of classified areas, which is a result of arranging receipt information, are received from the receipt information matching system. It determines whether the received data is inward classification information or outward classification information to be used for auto-classification and classifies the received data at step S903 and S904. The received receipt information is stored by creating a storing space for reception office and customer IDs in corresponding inward or outward classification storing unit, and the previous receipt information is removed at step S905 and S906. If it necessary, a method for storing and using the inward classification receipt information in the outward classification information storing unit without classifying the received data into the inward and the outward classification receipt information.

In the steps S905 and S906, the stored receipt information is searched when no postcode barcode is present in order to automatically sort and create the delivery information. After the outward classification, an object to process as the inward classification is recognized as the outward classification information and stored in the outward classification receipt information storing unit.

FIG. 6G is a flowchart showing a step for automatically processing special mail and automatically processing articles having a barcode without a postcode through searching receipt information in accordance with an embodiment of the present invention.

At step S1001, it determines whether a return and reply ID is present at an article or not when the article is supplied to an auto-sort and delivery information creating system. At steps S1002 and S1003, the barcode of the article is read and the number of digits and the classification information are checked.

After checking the results at steps S1002 and S1003, if the barcode cannot be read, the article is delivered to a non-sort section at step S1017, and the article is manually processed at step S1018.

After checking the results at steps S1002 and S1003, if the barcode can be read, a plan for sorting is checked at step S1004, and it determines whether sort-information such as a postcode is present or not at step S1005.

If the sort-information is present at step S1005, a current auto-processing system checks the classification information according whether it is inward classification information or outward classification information at steps S1006 and S1007. In case of the outward classification information, the articles are delivered to an outward section mapped to a postcode at step S1010. If no number for section is present, the articles are sorted as no-classification information at step S1008. When the classification plan changes, the articles are processed as re-supply articles at step S1009. In case of the inward classification information, the articles are delivered to an inward section mapped to a postcode at step S1010. In case of no number for section, the articles are classified as no-classification at step S1008.

Meanwhile, if no classification information such as a postcode in the read barcode of article is present at step S1005, it determines whether a symbol for reception office or a customer ID is present or not. If the symbol for reception office is present, it searches an article ID in the reception office symbol of inward classification. If the customer ID is present, the article ID arranged according to the customer ID is searched, and a postcode included in the article ID is obtained at step S1014.

In the step S1014, if the result of searching is present at step S1015, the searched field is marked as read at step S1016. If the article ID or the postcode is not present at step S1015, the step S1017 for delivering the articles to non-classification is performed.

Meanwhile, if the field is marked as read at step S1016, the article is delivered to an outward section mapped to a postcode for the delivery information at step S1010. If no section number is present, the article is processed as no-classification information. In case of the inward classification information, the articles are delivered to an inward section mapped to a postcode at step S1010. If no section number is present, the articles are processed as no-classification information at steps S1008 and S1009. Therefore, the articles are automatically processed although the classification information such as a postcode is not present at the articles.

If a return and reply ID is recognized in the steps at step S1001, and if the barcode of the articles are read at steps S1002 and S1003, the articles are automatically processed through the step S1005 for checking the sorting plan and the step S1014 for searching classification information. In case of the return and reply ID, it searches a customer ID transferred from a return information transferring unit or a postcode storing unit of a reception office at step S1014. If a postcode is present, the current auto-processing system automatically processes the articles by checking classification information according to whether the inward classification information or the outward classification information at step S1006 and S1007.

If a large quantity of articles with a barcode printed at same location thereof is received, the unnecessary area of articles is not scanned by assigning a coordinate for the area of the barcode.

Meanwhile, it determines whether each of the sorting sections is overflowed by articles delivered to corresponding sorting sections or not at step S1011. In case of no overflow, the data fields such as an article ID and a postcode which are obtained in a unit of a sorting section from the results of reading a barcode and searching receipt information are stored in a temporal storing unit at step S1012. If the sorting section is overflowed, the results are not stored in the temporal storing unit, and the articles are delivered to a re-supply sorting section to auto-process when the articles are re-supplied. Then, the mark for reading is released at step S1013.

When an article for return and reply is received, the postcode of a major customer ID or an article ID is transferred to a corresponding distribution center. The auto-processing system automatically sorts and delivers the articles to the section for return and reply according to the result of reading the return and reply symbol.

FIG. 6H is a flowchart showing a step for creating delivery information using the result of auto-classification for a special service in accordance with an embodiment of the present invention. FIG. 6H shows a step for automatically creating taking-over information and delivery information required for transferring the result of classification in FIG. 6G and the articles to other area.

At steps S1101 and S1102, the articles are packaged before a corresponding section is filled up with the articles while delivering the articles to the corresponding section. When the articles is no longer to convey to the corresponding section because the package box is filled up with the articles or the sorting process ends at step S1103, a barcode with a section ID assigned or a RFID Tag is read using a portable terminal at step S1104. After recognizing the barcode or the RFID Tag, it determines whether the result thereof is displayed at the portable terminal or the display light of corresponding section is turned on at steps S1105 and S1106. If the result of turning on the display light is normal, the barcodes of the first loaded article and the lastly loaded article in the package box are red at step S1110.

If the result of recognition is normal at step S1111, a barcode with a destination or a RFID tag attached at the packaging box is read at step S1112. If the recognition of the barcode or the RFID tag is normally performed at step S1113, the total amount of the articles in the packaging box, the article IDs in a stacking order, a reception office ID or a customer ID are combined with the destination ID, and the combined data is stored. Afterward, the delivery information thereof is created. If an error is present through an inspecting the weight of the articles, the error is corrected and transferred to the POSTNET at step S1116.

Meanwhile, if the barcodes of the sorting sections or the articles are the barcode or the RFID Tag attached at the packaging box are not recognized at steps S1105, S1111 and S1113, previous steps are performed. If the display lights of the sorting sections are not turned on or the processing result displayed at the portable terminal is not normal at step S1107, the processing result of a temporal buffer that manages the flow of creating the delivery information is removed at step S1108 in order to re-perform a taking-over process.

Also, if the articles are classified into outward classification using the receipt information or required to re-perform inward classification after creating the delivery information, it is marked as a read so as to remove from the outward classification receipt information storing unit, an inward classification ID is assigned thereto, and it is stored in the temporal storing unit at step S1114. Although the read marked receipt information is removed from the receipt information storing unit in the auto-processing system, the receipt information marked as the inward classification object is stored in the temporal storing unit at step S1115. The result thereof is combined with the result of receiving new receipt information by the receipt information matching system, and the combined data is reused.

As described above, the system and method for automatic processing of special service logistic according to the present invention automatically sorts articles and creates delivery information thereof using receipt information although the articles do not include classification information. The system and method for automatic processing of special service logistic according to the present invention also automatically processes return and reply articles through previously registering and simple symbol recognition. After creating the delivery information, the system and the method according to the present invention allows a portable terminal to read the barcode of the sorting section and the barcode of the article in order to delivery the articles through combining the result of processing the same type of articles and the result of manual process. Also, the system and the method according to the present invention provides a method for creating delivery information and a method for loading the articles by recognizing and combining the barcode or the RFID Tag attached at the packaging box, inputting the result of manual process, and reading the barcodes of the first loaded article and the lastly loaded article.

The system and method for automatic processing of special service logistic according to the present invention creates a service identification code, for example, 1 for a delivery service and 2 for return and reply article, the name of a distribution center including location information or the name of region, the time of ending a process, and an article barcode number, and transfers the created data to the POSTNET in order to notice the result of processing for the articles to customers. The POSTNET may transmit an e-mail or a text message with the processing result to the registered customers.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

The system and method for automatic processing of special service logistic according to the present invention improves the rate of auto processing articles and provides the reliability and the security of the processing result through automatically processing the article and creating the delivery information thereof using receipt information although a postcode is not present in a barcode. The system and method for automatic processing of special service logistic according to the present invention provides a method for transferring the receipt information to a corresponding distribution center to allow the auto-processing system to search the receipt information in real time, a method for storing and searching the receipt information in the auto-processing system, and a method for removing the used receipt information. When the barcode of article does not include classification information, the system and method for automatic processing of special service logistic according to the present invention uses the receipt information to automatically process the articles instead of printing and reading a fluorescence barcode, and video coding in order to improve the rate of auto-processing. Also, the return and reply articles can be automatically processed based on the inputted or the registered information according to the present invention when the return and reply articles are received.

Also, the quality of corresponding services is improved, and factors degrading the quality of distribution service due to increment of objects for manual process are removed by minimizing faulty outward caused by faulty recognition. Also, the operating cost is minimized, and the distribution operation can be smoothly performed by automatically processing the return and reply articles.

The present application contains subject matter related to Korean patent applications No. 2005-0121052 and No. 2006-0055077 filed in the Korean patent office on Dec. 9, 2005 and Jun. 19, 2006, the entire contents of which being incorporated herein by reference.

While the present invention has been described with respect to certain preferred embodiments, it will be apparent to those skilled in the art that various changes and modifications may be made without departing from the spirits and scope of the invention as defined in the following claims.

What is claimed is:

1. A system for automatic processing of special service logistic, comprising:
an article receiving means for sorting target articles by a type using receipt information and transferring the sorted articles to a distribution center;
an article integrated information means for receiving receipt information from the article receiving means, classifying the received receipt information by the distribution center that performs outward classification and inward classification and transferring the classified receipt information to the distribution center;
a receipt information matching means for classifying the receipt information into outward classification and inward classification by transferring the receipt information from the article integrated information means to the article receiving means, arranging the receipt information in an assigned order to provide a special service by a reception office and a customer ID, selectively using an inward classification storing unit regardless of outward and inward classification information, transferring the receipt information to an auto-sort and delivery information creating means, and removing and managing receipt information used by the result of ended operation and having an expired valid date;
an auto-sort and delivery information generating means for storing receipt information received by the receipt information matching means into a predetermined database, reading a barcode of mail supplied for auto-processing, delivering the supplied mail to a corresponding sorting section if a postcode is present in the mail, automatically processing articles by searching a postcode from the database if the postcode is not present, and automatically creating delivery information with article information included in a packaging operation of the articles in a sorting section;
an distribution center interfacing means for marking receipt information used at the auto-sort and delivery information creating means and transferring the marked receipt information to the receipt information matching means, and transferring the delivery information to the article integrated information means; and
a return and reply information processing means for receiving and processing a special service return and reply article.

2. The system as recited in claim 1, wherein the article receiving means includes:
a reception file sorting/postcode correcting means receiving a large quantity of articles and receipt information files thereof from a customer, inspecting the receipt information file and correcting wrong postcodes;
a receipt information inputting means for inputting receipt information for articles from the customer;
a receipt information generating means for creating receipt information by combining information inputted from the receipt information inputting means and the postcode;
a pre-printed barcode inspecting means for detecting a case that a postcode is present at receipt information files of a large quantity of the articles from the customer and the postcode is not present at a barcode;
a receipt information transferring means for transferring the receipt information created from the receipt information creating means to the article integrated information means;
a barcode printing means for printing a barcode attached at the article; and
a delivery information creating result confirming and transferring means for confirming the created delivery information and transferring the delivery information.

3. The system as recited in claim 1, wherein the receipt information is classified by a type of mail, a type of service, a destination, and a sorting plan, and includes a weight and a data of receiving.

4. The system as recited in claim 1, wherein the receipt information matching means includes:
a receipt information receiving state confirming, classifying and transferring means for receiving the receipt information from the article integrated information means, classifying the received receipt information into a letter and a parcel, sorting the received receipt information into outward classification and inward classification and transferring the sorted receipt information;
an outward classification receipt information receiving means for receiving the outward classification receipt information classified at the receipt information receiving state confirming, classifying and transferring means;
an inward classification receipt information receiving means for receiving the inward classification receipt information classified at the receipt information receiving state confirming, classifying and transferring means;
a delivery information comparing means for comparing the receipt information received from the inward classification receipt information to determine whether the receipt information is delivery information or not;
an outward classification information storing unit for storing the outward classification information;
an inward classification information storing unit for storing the inward classification information;
a receipt information sorting means for arranging the receipt information and non-classified information;
an auto-processed data transferring/obtaining means for transferring the receipt information arranged at the receipt information sorting means to be stored;
a delivery information result processing means for converting delivery information to be a data format to transfer to the article integrated information means when the delivery information is received as a classification result and preparing to transfer a result to a mobile service in a distribution center; and
an auto-processing result transferring means for checking a time assigned to transfer delivery information as the result of processing in the delivery information result processing means after outward/inward classification and a connection state of the article integrated information means for transferring the delivery information, and transferring the delivery information.

5. The system as recited in claim 1, wherein the auto-sorting and delivery information creating means includes:
a receipt information receiving means for receiving receipt information by an auto-processing data transfer/obtain processing means of the receipt information matching means;
an outward/inward classification information comparing means for identifying outward information and inward information from the receipt information of the receipt information receiving means;
a receipt information managing and sort plan data managing unit for classifying the compared data in the outward/inward classification information comparing means into outward information and inward information, and managing the classified outward information and inward information;
an outward classification information storing unit for storing outward information not classified from the outward/inward classification information in the outward/inward classification information comparing means;
an inward classification information storing unit for storing inward classification information classified at the outward/inward classification information comparing means;
a sort-plan storing unit for storing information of sorting sections;
a back-up storing unit for backing up data of the outward classification information storing unit, the inward classification storing unit and the sort-plan storing unit, and storing the backed up data;
a barcode reading means for reading a barcode attached at an article to auto-classify;
a reading result comparing means for inspecting the barcode reading result to include a postcode;
a sort-plan/sorting ID searching means for setting up a plan for classifying outward and inward corresponding to a postcode when the postcode is present in a barcode from the compared information from the reading result comparing means;
a sorting result processing means for searching sorting section information from the sort-plan storing means according to the result of the sort-plan/sorting ID searching means, and delivering articles into corresponding sorting section according to the result of searching;
a receipt information search processing means for searching receipt information from the outward classification information storing unit, the inward classification storing unit and the sort-plan storing unit;
a delivery information creating, inspecting and correcting means for creating the delivery information using a result processed in the sort result processing means, inspecting the created delivery information and correcting the inspected delivery information;
a delivery information and a using result transferring means for transferring a result of marking used receipt information in the delivery information creating, inspecting and correcting means and delivery information to the receipt information matching means and the article integrated information means; and
a return and reply ID recognizing means for recognizing a return and reply ID.

6. The system as recited in claim 5, wherein the delivery information creating, inspecting and correcting means reads and removes a registered barcode of a faulty sorted mail when detecting the faulty sorted mail after/before packaging the sorted mails, and reads a registered barcode of a faulty sorted registered mail and automatically removes the faulty sorted registered number after transiting an operating mode to ‘faulty sort result removing mode’ when a large quantity of mails are faulty sorted.

7. The system as recited in claim 1, wherein the return and reply information process transferring means includes:
a return and reply symbol attaching means for attaching a return and reply symbol at a predetermined location of an article for return and reply;
a symbol barcode reading means for reading a barcode attached at the return and reply symbol attaching means;
an article ID searching means for searching a sender's postcode in the article integrated information means by the barcode information read at the symbol barcode reading means; and
a return information transferring means for registering the information searched at the article ID searching means for transferring the return information, and transferring the searched information to the article integrated information means.

8. A method for automatic processing of special service logistic, comprising the steps of:
a) transferring receipt information and delivery information by receiving an article for a special service;
b) distributing the receipt information created at the step a) from an article integrated information system to each distribution center;
c) matching the receipt information from the article integrated information system to the distribution center receipt information matching system and transferring the receipt information;
d) removing receipt information after automatically classifying and creating delivery information at the receipt information matching system and providing residual state information of the receipt information;
e) removing unnecessary receipt information using a result of manual process by the distribution center receipt information matching system;
f) storing receipt information received by the auto sorting process;
g) automatically sorting and processing articles for a special service; and
h) creating delivery information using a result of auto sorting the articles for special service.

9. The method as recited in claim 8, wherein the step a) includes the steps of:
a1) uploading or inputting a customer data file for received articles and determining whether a postcode is present or not;
a2) printing a barcode without a postcode if the postcode is not present, packaging the article with a box, creating delivery information, and transferring the created delivery information by accessing a distribution center gateway or a POSNET;
a3) determining whether the received article is a large quantity of articles or not if the postcode is present, printing a barcode with a postcode if the received article is not a large quantity of articles, and determining whether a barcode with a postcode is present or not if the received article is not a large quantity of articles;
a4) packaging the received article with a box if a barcode with a postcode is present, searching a postcode file and inputting a postcode or directly inputting a postcode if a barcode with a postcode is not present, confirming whether receipt information is inputted or not, and creating receipt information; and
a5) transferring the reception data created at the step a4) by accessing the distribution center gateway server or POSNET.

10. The method as recited in claim 8, wherein the step b) includes the steps of:
b1) receiving delivery information and receipt information from a reception office or a reception system of a distribution center and determining whether a postcode is included in the delivery information; and
b2) transferring the received delivery information to a corresponding distribution center if the received delivery information includes a postcode, recognizing the received delivery information as receipt information if the postcode is not included in the received delivery information, determining whether a postcode is present or not, classifying the deliver information into outward classification and inward classification, sorting the receipt information by destinations, and transferring the sorted receipt information to a distribution center gateway server.

11. The method as recited in claim 10, wherein the step c) includes the steps of:
c1) receiving reception data transmitted to the distribution center, determining whether the received reception data is outward classification information, inward and delivery information, or inward classification information, sorting the reception data by type, outward, inward and delivery information and storing the sorted reception data, or storing the reception data without sorting;
c2) determining whether un-used valid data is in reception data or not;
c3) determining whether a received article is a large quantity of articles or not if no un-used valid data is present, arranging reception data having an unique number of a major customer by a customer ID and an article ID, transmitting reception data to an auto-sort and delivery information processing system, determining whether a received article is not a large quantity of articles, arranging data of outward classification information and inward classification information by a reception office ID and an article ID, and transmitting receipt information to the auto-sort and delivery information system; and
c4) classifying un-used receipt information and newly received data into outward classification and inward classification if valid data is present, combining the classified receipt information, and performing the step c3).

12. The method as recited in claim 10, wherein the step d) includes the steps of:
d1) determining whether a manual process result is received, an auto sort result is received, and residual receipt information is present;
d2) determining whether usable receipt information is present or not through inspecting a history of storing results if the manual process result is not received and the residual receipt information is required to be confirmed, storing validity copying residual receipt information from outward and inward classification receipt information if receipt information is present, noticing a storing result for a requesting result, and transferring a no receipt information message if the receipt information is not present;
d3) receiving the result of using the receipt information with the result of creating delivery information as auto-sort completion data, transferring the result of creating delivery information to an article integrated information system (POSTNET), and determining whether receipt information included in used delivery information is outward classification information or inward classification information;
d4) storing corresponding data into an inward classification receipt information storing unit if it is an object for inward classification when the receipt information is the inward classification information, and removing used inward classification receipt information and data with an expired valid date;
d5) removing used outward classification receipt information and data with an expired valid date if it is inward classification information; and
d6) removing data in steps d4) and d5), and storing a history of usable residual data from the outward and inward classification receipt information.

13. The method as recited in claim 10, wherein the step e) includes the steps of:
e1) receiving a manual process classification and delivery information creating completion data from a receipt information matching system after manually classifying and creating delivery information, receiving a manual process classification completion data in case of a result of manual process, determining whether the result of manual process is outward classification information or inward classification information, sorting the result thereof, marking used data in outward classification receipt information by finding a same article ID, and marking used data in inward classification receipt information; and
e2) removing marked receipt information in outward and inward classification receipt information after searching all delivery information, storing the searched amount of articles, the number of removed receipt information, the number of residual receipt information, the used reception office according to the outward and inward classification receipt information, and the number of cases of usable customer IDs, adding newly received receipt information and previously received receipt information, and transferring minimum receipt information to an auto-processing system.

14. The method as recited in claim 13, wherein the step e1) includes the steps of:
e11) removing used information after a predetermined date passed after a reception data receiving date when information is used without marking.

15. The method as recited in claim 10, wherein the step f) includes the steps of:
f1) receiving data of sorting sections which are sorted receipt information result from the receipt information matching system, determining whether data is outward classification information or inward classification information to be used for auto sorting, adding received receipt information into reception offices and customer Id storing units in corresponding outward or inward classification storing units, and removing previous receipt information;
f2) searching reception data stored without outward and inward classification; and
f3) searching reception data when a barcode with postcode is not present in stored receipt information in the steps of f1) and f2), using the searched receipt information to auto sort and delivery information creation, recognizing the searched reception data as outward classification information when it is an object to be inward classified after outward classification, and storing the searched reception data in an outward classification receipt information storing unit.

16. The method as recited in claim 10, wherein the step g) includes the steps of:
g1) determining whether a return and reply ID is present at articles by supplying articles to the auto-sort and delivery information creating system, and checking a positional number and classification information by reading a barcode printed on the articles or attached at the articles;
g2) delivering the articles to an non-sort section if the barcode cannot be read, and manually processing the articles;
g3) checking a sort-plan if the barcode can be read, and determining whether classification information including a postcode is present or not;
g4) inspecting classification information according to whether the classification information is outward classification information or inward classification information by an auto-processing system when classification information is present, delivering the articles to an inward section mapped to a postcode in case of outward classification information, classifying it as no classification information when a corresponding sorting section number is not present to process it as re-supply article when a sort-plan changes, and classifying it as no classification information when a corresponding sorting section number is not present; and
g5) determining whether sorting sections are overflowed or not after delivering articles in corresponding sorting sections, storing data files including an article ID and a postcode which are obtained in a unit of a sorting section by a result of searching receipt information and a result of reading a barcode into a temporal storing unit when the sorting sections are not overflowed, and the results for a corresponding article is not stored and delivering the articles to a re-supply sorting section if the sorting section are overflowed, and releasing a read mark.

17. The method as recited in claim 10, wherein the step h) includes the steps of:
h1) packaging articles with a packaging box before sorting sections are filled up with articles while delivering articles to corresponding sorting sections, reading a barcode or a RID Tag with a sorting section ID using a portable terminal when no article is delivered to sorting sections, checking whether the result thereof is displayed at the portable terminal or an indicating light is turned on or off after reading the barcode or the RFID Tag, and reading barcodes of a first loaded article and a lastly loaded article in a packaging box if the result of turning on the indicating light is normal;
h2) reading a barcode or a RFID Tag with destination information attached at a packaging box if sorting sections are normally recognized, creating delivery information by storing the total amount of articles in a packaging box, article IDs in a stacking order, and a reception office or a customer ID with a destination ID if the recognition is normally performed, correcting an error through inspecting a weight of article, and transferring the delivery information to POSTNET;
h3) repeatedly recognizing barcodes of sorting sections and articles and a barcode or a RFID Tag attached at a packaging box when these are not recognized, removing a result of operating in a temporal buffer that manages an outward information creation operating flow when one of indicating lights of sorting sections are not turned on or the operating result displayed at a portable terminal is not normal, and performing the recognition process repeatedly; and
h4) marking receipt information as a read to remove the marked receipt information from an outward classification receipt information storing unit if the receipt information is outward classified and inward classification is required to perform after creating delivery information, storing the receipt information by assigning inward classification ID, removing the marked receipt information from a receipt information storing unit in an auto-processing system or storing receipt information marked as an object of inward classification into a temporal storing unit, and combining the result thereof with a result of receiving new receipt information by a receipt information matching system.

18. The method as recited in claim 10, wherein in the step h2), a one-digit service identification code, a distribution center name, a process completion time, and an article barcode number are created and they are transferred to POSTNET for noticing a result of processing to customer, and the POSTNET transmits a text message of the processing result through an E-mail or a portable telephone number which are registered to the POSTNET to notice the result of processing articles.
